(19) United States
(12) Patent Application Publication
(10) Pub. No.: US 2009/0305101 A1
(43) Pub. Date: Dec. 10, 2009

(54) Fuel Cell Apparatus Having a Current Sensor and a Current Sensor for a Fuel Cell Apparatus

(76) Inventors: Werner Belschner, Michelbach a.d. Bilz (DE); Matthias Kugel, Stuttgart (DE); Juergen Leitz, Dettlingen (DE); Ralf Mueller, Lobstaedt (DE)

Correspondence Address: CROWELL & MORING LLP;INTELLECTUAL PROPERTY GROUP, P.O. BOX 14300, WASHINGTON, DC, 20044-4300, US

(21) Appl. No.: 12/298,704

(22) PCT Filed: Apr. 28, 2006
(86) PCT No.: PCT/EP06/03964

§ 371 Date: Mar. 6, 2009

(51) Int. Cl. H01M 8/04

(52) U.S. Cl. 429/23

(57) ABSTRACT

A fuel cell apparatus includes at least one busbar for discharging high electrical currents from a high-voltage side of a fuel cell unit and a current sensor that comprises an evaluation electronics unit. A resistance element of the current sensor is integrated in the outgoing electrical conductor.

This application is a national stage of International Application No. PCT/EP2006/003964, filed Apr. 28, 2006, the entire disclosure of which is herein expressly incorporated by reference.

### BACKGROUND AND SUMMARY OF THE INVENTION

The invention relates to a fuel cell apparatus having a current sensor and to a current sensor for fuel cell apparatus.

German Published Patent Document DE 100 06 781 A1 discloses a fuel cell vehicle in which current generated by a fuel cell unit is detected by a current sensor mounted on the so-called high-voltage side of the fuel cell unit. The fuel cell unit consists of a stack of individual cells, so that a relatively high output voltage (“high voltage”) is emitted in nominal operation. Conversion of the signals of the current sensor requires an additional A/D converter (which simultaneously converts also the measured voltage on the high-voltage side), as well as a logic for controlling the latter. The signal is transmitted from the high-voltage side to the 12-V side via optical couplers. A relatively comprehensive evaluation electronics unit is required to evaluate the signals.

The current sensor itself requires a relatively large installation space, which is not readily available in vehicle-based fuel cell systems and, on the whole, causes a high weight. In addition, high demands are made with respect to precision, thermal stability and ruggedness for a use in the automotive field.

However, for high data transmission rates, no optical couplers are available which meet the other automotive demands. Furthermore, their thermal stability above 85° is critical. If the current sensor together with the entire circuit is housed on a common printed circuit board, either the maximum measurable current or the maximum achievable precision of the measurement is very limited because the heat conduction of the current sensor (normally a shunt resistor) mounted on the printed circuit board, presents a considerable problem.

If, as an alternative, the shunt resistor of the current sensor is connected by way of wires with its evaluation circuit, it is found that, even in the case of twisted wires, its susceptibility is relatively high. The lay-out value of the shunt resistor is normally a compromise between shunt losses and a desired high measuring voltage, so that usually only a few millivolts are available as the measuring signal. On this scale, the measuring signal is particularly susceptible. However, knowledge of the electric current supplied by the fuel cell unit that is as precise as possible is absolutely necessary.

One object of the present invention is to provide a fuel cell apparatus having a current sensor, as well as a current sensor for a fuel cell apparatus with a precise, reliable and space-saving current measurement.

This and other objects and advantages are achieved by the fuel cell apparatus according to the invention, which has at least one bus bar for discharging high electric currents, with a resistance element integrated, (particularly welded) into the outgoing current conductor. At the resistance element, the current flowing through the bus bar can easily be measured by way of a voltage drop. The resistance element thus forms a rugged, thermally stable and precise current sensor. Because the resistance element is integrated in the bus bar, the current sensor requires no additional installation space. The resistance element preferably has the same or a smaller cross-section than the bus bar itself. Only a few electric components are necessary for measuring and amplifying the voltage drop so that costs and space can be saved. The result is a very good heat conduction from the resistance element, which is advantageous, particularly in the case of high currents.

Advantageously, the current, the voltage at the fuel cell unit and the temperature of the fuel cell unit on the high-voltage side can be determined by the resistance element of the current sensor, which is constructed as a shunt resistor, in combination with a circuit (ASIC) adapted thereto. In a dc-decoupled manner, the measurement data are transmitted by way of so-called I-couplers to a low-voltage side. As a result, data transmission rates are no longer as limited as they are in the case of optical couplers.

Furthermore, high measuring accuracy and good thermal stability can be achieved, while the apparatus has small dimensions and a correspondingly low weight. In addition, a relatively high operating temperature of above 100° C. becomes possible while, at the same time, the current consumption and susceptibility are low. The bus bar typically has a relatively large cross-section of several square millimeters. The resistance element may have a smaller cross-section than the bus bar in order to generate a sufficiently high voltage drop at the current flow. The cross-section of the resistance element is expediently designed to be large enough to carry the normal operating currents of the fuel cell unit. In the case of higher currents, the bus bar advantageously transfers heat from the resistance element rapidly and effectively. A resistance alloy with low temperature coefficients, low thermoelectric voltage, high long-time stability and high load capacity is a preferred material for the resistance element, which is preferably constructed as a shunt resistor. Alloys such as manganin or constantan are preferred.

The resistance element is preferably welded in between two sections of the bus bar. A suitable resistance element can be easily adapted to different fuel cell units and thus to different marginal electric conditions. As a result of the welded connection, very good heat conduction is achieved from the resistance element into the bus bar.

The heat conduction of the current sensor can be improved further by soldering its electronic evaluation unit to the resistance element and/or the bus bar. The result is an advantageously short lead to the electronic evaluation unit, which is therefore in direct solid-state heat-conducting contact either with the resistance element, with the bus bar or with the bus bar and the resistance element. This permits a targeted and planned heat conduction and heat distribution. Simultaneously, the electronic evaluation is in an intimate contact with the bus bar in all cases.

Advantageously, the electronic evaluation unit may be arranged on a printed circuit board which is soldered to connect the resistance element and/or the bus bar. The printed circuit board is preferably constructed in several layers in order to be able to carry strip conductors at different levels for electrically wiring the electronic elements on its top side and, as necessary, on individual layers. The electronic evaluation unit preferably comprises a customer-specific integrated circuit, also known an ASIC, as well as a temperature sensor and a voltage measuring device for measuring the output voltage of the fuel cell unit.

When the printed circuit board has metallized connection surfaces for mechanically and electrically bonding the printed circuit board, a favorable soldering process with an advantageous controllability becomes possible. In addition, a very favorable mechanical durability during temperature changes over the service life of the fuel cell apparatus and of the current sensor respectively is achieved. Advantageously, the connection surfaces may extend through a plurality of layers of the printed circuit board. Advantageous through-platings of different sizes may extend through a plurality of different levels in the printed circuit board.

For transmission of measuring signals of the electronic evaluation unit from the high-voltage side to the low-voltage side, dc decoupling (preferably by way of a so-called I-coupler) may be provided. Optical couplers are therefore unnecessary, and the electronic evaluation unit can be optimized for automotive use under correspondingly unfavorable environmental specifications.

The current consumption of the current coupler is clearly more favorable than that of optical couplers, particularly at higher data transmission rates. In addition, this results in a higher permissible ambient temperature of the current sensor, in a direct manner, as a result of a higher possible temperature range when in use and, indirectly, as a result of the lower current demand and therefore in a lower necessary DC/DC converter power.

As a result, a cost-effective, very small DC/DC converter can be used, as it is commercially available.

A current sensor according to the invention, particularly for a fuel cell apparatus, comprises a resistance element, which is made to be welded into an outgoing electrical conductor. Advantageous heat conduction and a higher loading of the current sensor, particularly in the case of automotive use conditions, thereby becomes possible.

Preferably, an electronic evaluation unit can be soldered to the resistance element and/or the bus bar, particularly on the left and the right of the welded-in resistance element. The resulting targeted and planned heat conduction and heat distribution permits a more reliable current measurement with higher accuracy under difficult use conditions in the automotive field. Similarly, by direct or indirect intimate coupling onto the bus bar, reliable temperature measurement of the bus bar is possible. In addition to the current measurement, the current sensor has a temperature sensor as well as a voltage sensor for the determination of an output voltage.

The electronic evaluation unit is preferably arranged on a printed circuit board which is constructed in several layers and can be soldered together with the resistance element and/or the bus bar, for example on the left and the right of the welded-in resistance element.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic view of a fuel cell unit having a resistance element of a current sensor according to the invention;

FIG. 2 is a schematic view of a current sensor in a vehicle-based fuel cell system; and

FIG. 3 is a simplified block diagram of a current sensor.

### DETAILED DESCRIPTION OF THE DRAWINGS

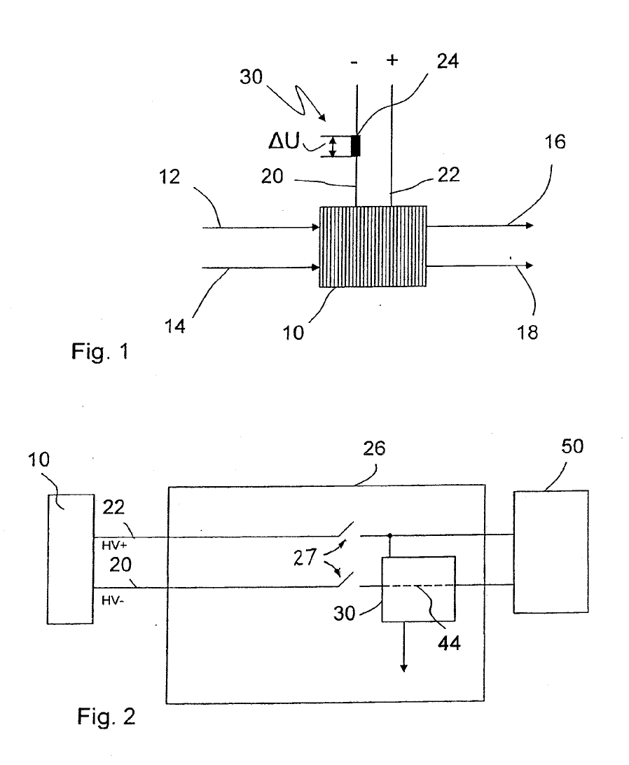

FIG. 1 is a simplified illustration of a fuel cell apparatus according to the invention having a fuel cell unit 10 and two bus bars 20, 22 for discharging electric current from the fuel cell unit to consuming devices (not shown), such as for example, a vehicle equipped with a fuel cell system. The bus bars 20, 22 are massive copper leads having a typical cross-section of several mm2. Typical electric voltages of the fuel cell unit are at approximately 200 V-400 V.

An oxidizing agent, such as air, and a reducing agent, such as hydrogen, are fed to the fuel cell unit 10 on the input side by way of agent pipes 12, 14. In the fuel cell unit, an electrochemical reaction takes place during which voltage is generated and current can be collected from the fuel cell unit. On the exhaust gas side, reaction products can be discharged via exhaust pipes 16, 18. Additional details of the pertaining fuel cell system or of the fuel cell unit 10 are not shown but are known to the person skilled in the art.

A resistance element 24 is welded between two sections of the bus bar 20, which are not indicated in further detail. The resistance element, which is constructed as a shunt resistor and is a component of a current sensor 30, has, for example, a smaller cross-section than the bus bar 20. Independently of the current sensor 30, the bus bar 20 itself can be optimized for its actual purpose, which is the current discharge from the fuel cell unit 10. The resistance R and temperature coefficient of the resistance element 24 are known and can be precisely determined before the insertion, or can be taken into account by calibration after the welding-in. The size of the resistance element 24 or its resistance R can be selected so that it is appropriate for the fuel cell unit 10.

From the voltage drop ΔU over the resistance element 24, the current I which flows through the resistance element 24, and thus through the bus bar 20, can be determined using the relationship ΔU=R·I. The voltage drop ΔU is amplified electronically and the flowing current I is determined by way of the known electric resistance R of the resistance element 24.

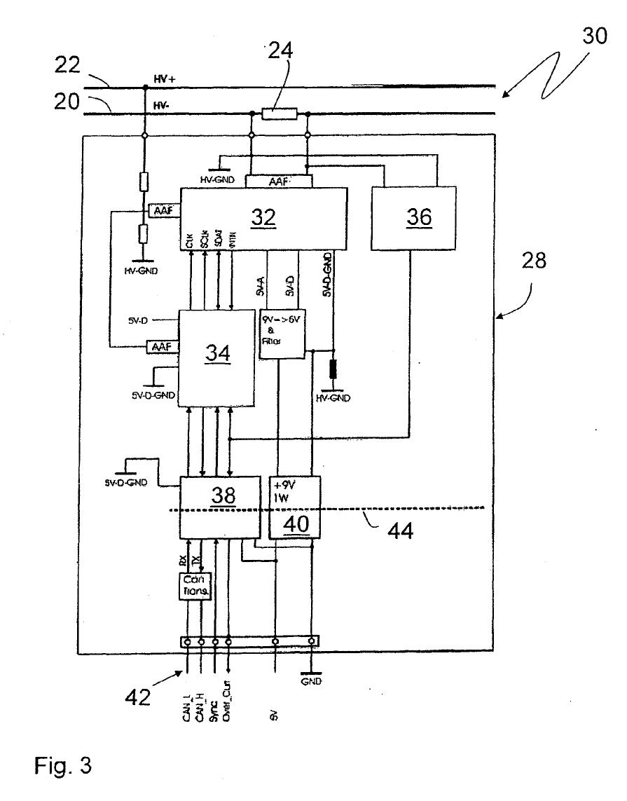

In addition to the resistance element 24, the current sensor 30 comprises an electronic evaluation unit 28 which is soldered to the resistance element 24 integrated in the bus bar 20 and/or to the bus bar 20, for example, directly on the left and on the right of the welded-in resistance element, as shown in FIG. 3. This type of connection provides an intimate solid-state heat-conducting contact between the electronic evaluation unit 28 and the resistance element 24 and/or the bus bar 20, with very short connection lines between the resistance element 24 and the electronic evaluation unit 28.

FIG. 2 is a schematic view of the current sensor 30 in a vehicle-based fuel cell system having a fuel cell unit 10, a power distribution unit (PDU) 26 and consuming devices 50 which are arranged in a vehicle wiring system and/or an electric supply system of the fuel cell unit 10, for example, a compressor for the air supply of the fuel cell unit 10, feed pumps, and the like.

The current sensor 30 is integrated in the PDU unit 26. Switches 27 for separating the fuel cell unit 10 from the consuming devices 50 are provided between the current sensor 30 and the fuel cell unit 10. The current sensor 30 is placed on the high-voltage side of the fuel cell unit 10, and do decoupling 44 is provided between the high-voltage side (for example, 200V nominal voltage) and a low-voltage side (for example, 12V nominal voltage). On the high-voltage side of the current sensor 30, the current, the voltage and the temperature of the fuel cell unit 10 are detected, calibrated and processed. Subsequently, they are transmitted by way of an I-coupler to the low-voltage side. The current is detected by the resistance element 24, while a temperature sensor is integrated in the electronic evaluation unit 28 for measuring the temperature.

The construction of the current sensor 30 is explained in a simplified block diagram which is illustrated in FIG. 3.

The resistance element 24 is welded into the bus bar 20 which, in the illustrated embodiment, is at the negative potential HV−. The electronic evaluation unit 28 is arranged on a preferably multilayer printed circuit board (not shown in detail), and is soldered to the resistance element 24.

The electronic evaluation unit 28 comprises an application-specific integrated circuit 32 (ASIC), with the printed circuit board having metallic (particularly cooper) connection surfaces, for mechanical and electric bonding of the printed circuit board onto the bus bar and/or the electronic evaluation unit 28. The metallic connection surfaces preferably have metallic surfaces in all layers of the printed circuit board. Furthermore, through-platings of different sizes extend in-between through all layers in the printed circuit board. The circuit 32 provides measuring signals with respect to current from the fuel cell unit 10, voltage at the output of the fuel cell unit 10 and temperature of the fuel cell unit 10.

The integrated circuit 32 is connected with a controller unit 34, which also directly measures the electric voltage at the output of the fuel cell unit 10 (FIGS. 1, 2) in order to permit a plausibility consideration of the measurement data of the integrated circuit 32. High-quality low-pass filters, so-called AAF filters (anti-aliasing filters), are provided at signal inputs of the integrated circuit 32 and of the controller unit 34.

Furthermore, a unit 36 provides overcurrent detection. Its measurement data are supplied to the controller unit and are also emitted directly to the outside as a hardware signal.

It is possible to synchronize the sampling or down-sampling of the measurement data from the outside with other measurements.

A so-called I-coupler 38 with a dc decoupling 44 is provided for transmission of measuring signals from the high-voltage side of the electronic evaluation unit 28 to the low-voltage side. A digital interface 42 of the current sensor is preferably constructed as a CAN. (However, any other digital interface may also be selected.)

Because of the low power consumption of the current sensor 30 of, for example, 0.25 W, a simple and cost-effective 1 W DC/DC converter 40 can be used. Nevertheless, a sufficient reserve remains for a derating of the output power at a higher temperature. However, basically, a power transmitter operating according to the piezo principle could also be used.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-14. (canceled)

15. Fuel cell apparatus comprising:
at least one bus bar for discharging high electric currents from a high-voltage side of a fuel cell unit that has a current sensor comprising an electronic evaluation unit; and
a resistance element of the current sensor;
wherein the resistance element is integrated in an outgoing electrical conductor of said at least one bus bar.

16. The fuel cell apparatus according to claim 15, wherein the resistance element is welded between two sections of the at least one bus bar.

17. The fuel cell apparatus according to claim 15, wherein the electronic evaluation unit is soldered to the resistance element and/or the at least one bus bar.

18. The fuel cell apparatus according to claim 15, wherein:
the electronic evaluation unit is arranged on a printed circuit board; and
the printed circuit board is soldered to one of the resistance element and the at least one bus bar.

19. The fuel cell apparatus according to claim 18, wherein the printed circuit board is soldered to the resistance element at an edge of the resistance element.

20. The fuel cell apparatus according to claim 18, wherein the electronic evaluation unit has an application-specific integrated circuit.

21. The fuel cell apparatus according to claim 18, wherein the printed circuit board has metallized connection surfaces for mechanical and electric bonding of at least one of the printed circuit board and the electronic evaluation unit.

22. The fuel cell apparatus according to claim 21, wherein the connection surfaces extend through a plurality of levels of the printed circuit board.

23. The fuel cell apparatus according to claim 21, wherein through-platings of different sizes extend through a plurality of levels in the printed circuit board.

24. The fuel cell apparatus according to claim 15, wherein dc decoupling is provided for the transmission of measuring signals of the electronic evaluation unit from the high-voltage side to a low-voltage side.

25. The fuel cell apparatus according to claim 24, wherein an I-coupler is provided for transmission of measuring signals of the electronic evaluation unit.

26. A current sensor for a fuel cell apparatus, according to claim 15, wherein the resistance element is constructed for the welding into an outgoing electric conductor.

27. The current sensor according to claim 26, wherein an electronic evaluation unit can be soldered at least in areas to at least one of the resistance element and the outgoing electric conductor.

28. The current sensor according to claim 27, wherein the electronic evaluation unit is arranged on a printed circuit board, which can be soldered to at least one of the resistance element and the outgoing electrical conductor.
